(19) United States
(12) Patent Application Publication
(10) Pub. No.: US 2021/0262597 A1
(43) Pub. Date: Aug. 26, 2021

(54) TELESCOPIC TUBE AND METHOD FOR THE MANUFACTURE THEREOF

(71) Applicant: Hongxuan Chen, Hangzhou (CN)

(72) Inventor: Hongxuan Chen, Hangzhou (CN)

(21) Appl. No.: 15/930,347

(22) Filed: May 12, 2020

(30) Foreign Application Priority Data
Feb. 26, 2020 (CN) 202010121332.0

(51) Int. Cl. F16L 23/036; F16L 11/15; F16L 23/12

(52) U.S. Cl. CPC F16L 23/036; F16L 23/12; F16L 11/15

(57) ABSTRACT

A telescopic tube and methods of manufacturing it are disclosed. The manufacturing method includes placing a connecting ring around a tube body of the telescopic tube, then forming a connecting tube at one end of the tube body by injection molding so that the connecting ring is positioned between the connecting tube and the other end of the tube body. The method further includes coupling the connecting ring with the connecting tube.

### TECHNICAL FIELD

This specification relates to the field of fluid conveying equipment and technology, and particularly, a telescopic tube and methods for its manufacture.

### BACKGROUND

A telescopic tube (or telescopic hose, telescopic pipe, etc., all of which are used interchangeably with “telescopic tube” in this specification) is a component commonly used in fluid conveying equipment, such as a vacuum pipe of a vacuum cleaner, a steam pipe of an ironing machine, etc. A telescopic tube is usually composed of a tube body and a joint, which are connected with each other. Because such a telescopic tube is typically used in a fluid conveying equipment, the effect or performance of sealing between the tube body and the joint is particularly important.

For existing telescopic tubes and their manufacturing methods, since the tube body is typically a threaded corrugated pipe or a similar structure, internal threads are generally provided on the inner wall of the joint, and correspondingly, external threads are generally provided on the outer wall of the tube body. Thus, the tube body and the joint are connected by screwing the internal threads with the external threads. Next, glue is applied to the connection of the internal threads and the external threads to fix the tube body with the joint. Since the joint is typically made of relatively hard material such as, for example, hard PVC (polyvinyl chloride) material, the connection of the joint and the tube body is covered by glue on its outer surface to form a sealing edge, so to achieve better sealing performance when the joint is connected to other components of the fluid conveying equipment (e.g., a vacuum cleaner or ironing machine).

In the existing manufacturing method described above, the connection of the tube body and joint is sealed by first connecting the two components using threads and then applying glue around the connection. Such a connection in a fluid conveying equipment (e.g., vacuum cleaner, ironing machine, etc.), however, when in use needs to be turned frequently. Therefore, the connection between the tube body and joint is prone to be disconnected, loosen or degummed. In other words, when the fluid conveying equipment is in use, its frequent turning will make the screw connection loosen and/or the glue degummed, potentially generating gaps between the tube body and joint, and as a result, the fluid flowing inside the tube body will leak from the gaps.

In view of above deficiencies of the existing telescopic tubes and the method of manufacturing them, a more effective solution to address these issues, including a telescopic tube that achieves better sealing performance and methods of manufacturing such a telescopic tube, would be advantageous and desired.

### SUMMARY

This specification describes telescopic tubes that overcome the deficiencies of existing telescopic tubes and the methods for manufacturing such improved telescopic tubes.

A method of manufacturing telescopic tubes includes the following steps:

Step 1: placing a connecting ring around a tube body of a telescopic tube.

Step 2: forming a connecting tube at one end of the tube body by injection molding so that the connecting ring is positioned between the connecting tube and the other end of the tube body.

Step 3: coupling the connecting ring with the connecting tube.

Particularly, the connecting tube is formed by directly injection molding it onto the end of the tube body, so that the tube body and the connecting tube are integrated into one piece of component. Once formed into one piece, the two otherwise separate or loosely-coupled components are tightly bonded and glued together. Such a connection is stronger, and the seal performance between them is better in that there is little to no gap for leaking fluid. Even when the tube body and the connecting tube are constantly turned and twisted back and forth, the connection between the two will not be loosened or disconnected, and the fluid flowing through the tube body will not leak. As a result, the telescopic tube has a better quality, is stronger, safer and more robust and durable, and thus has a longer lifetime.

Furthermore, in manufacturing the existing telescopic tubes, the tube body and the joint are connected by first screwing them together, then applying glue on the screwed connection, and last covering glue on the outer surface of the connection to form a sealing around it. Such a process, however, is very time-consuming and labor-intensive if the screwing has to be manually operated. Otherwise, if the screwing is automatically operated by machines, it is still vulnerable and prone to defects due to the fact that the tube body is relatively soft (i.e., not made of hard PVC) and thus prone to deformation. Specifically, it is not easy for a machine to align the end of the tube body with the joint, which causes high failure rates for connecting the two, and as a result, leading to higher scrap rates and higher cost for the manufacture.

Additionally, when applying glue on the connection of the tube body and the joint to fix and seal the connection, if insufficient glue is applied, it will lead to poor sealing effect and thus fluid leaking. Otherwise, if excessive glue is applied, the excess glue, after solidification, will likely form plugs protruding from the surface of the joint or the tube body. Such protruding plugs, when the fluid flows through the telescopic tube, will likely function as obstacles to hinder the passing of the fluid, and will also likely create abnormal noises, all leading to higher scrap rates.

Completely different from the existing manufacturing method described above, in the new manufacturing method described in this specification, the connecting tube is formed by directly injection molding it onto the end of the tube body. Particularly, to overcome the problem of weak connection and poor sealing between the tube body and the joint, unlike the existing method, the new method does not need to replace the glue with a better, stickier glue or increase the sealing ring for interference fit. Instead, the new method achieves stronger connection and better sealing effect by directly injection molding the connecting tube onto the end of the tube body.

Also, the manufacturing method described in this specification requires only one step to achieve the fixing and sealing between the tube body and the connecting tube. Therefore, it simplifies the manufacturing process when compared with the existing manufacturing method. As a result, it improves the manufacturing efficiency and reduces cost in labor, material and time. Furthermore, because the injection molding is a mature and well developed technique, high yield and good quality can both be guaranteed. Thus, overall the new manufacturing method is an obvious and significant improvement compared with the existing manufacturing method.

In some embodiments, prior to forming the connecting tube at the end of the tube body at Step 2, the method includes stretching and extending the tube body. By this operation, when the connecting tube is formed on the tube body by injection molding, the surface of the connecting body has a more sufficient and broad direct contact with the surface of the tube body, thus making the connection between the connecting tube and the tube body stronger and achieving a better sealing effect. Meanwhile, the tube body performs better in supporting and fixing the connecting tube because of the sufficient contact between these two components, which makes the connecting tube stronger, less prone to deformation, and more durable.

In some embodiments, prior to placing the connecting ring around the tube body, the method includes: forming a metallic wire into a coil spring; stretching and extending the coil spring; and curing the stretched coil spring to form the tube body. In some embodiments, the stretching and extending the coil spring and the curing the stretched coil spring to form the tube body are performed simultaneously. By performing those operations, the tube body does not need to be stretched and extended again before the connecting tube is formed by injection molding. Thus, the manufacturing process is simplified and the production efficiency is improved.

This specification also describes a telescopic tube made by the manufacturing methods described herein. Specifically, in some embodiments, such a telescopic tube includes a tube body; a connecting tube formed at one end of the tube body by injection molding; and a connecting ring placed around the tube body and positioned between the connecting tube and the other end of the tube body. By forming the connecting tube at the end of the tube body by direct injection molding, it not only makes the manufacturing process easier and more productive, but also makes the connection between the connecting tube and the tube body stronger, tighter, and sealed better.

In some embodiments, the connecting ring and the connecting tube are detachably coupled with each other by a connection structure. Such a connection structure can include, for example, a thread, a buckle, and/or a slot. The connection structure is designed to connect or couple the connecting ring and the connecting tube in an easy and effective manner that makes the connection strong, stable and durable.

In sum, this specification describes a method to manufacture a telescopic tube by forming a connecting tube on the tube body of the telescopic tube through direct injection molding. As a result, the connection between the connecting tube and the tube body is stronger and achieves better sealing effect when compared with existing manufacturing methods, and thus effectively reducing fluid leaking. Therefore, the resulted telescopic tube is stronger, safer, more durable and lasting, and the manufacturing method is simplified, reduces cost in labor, material and time, and yields more high-quality products.

### BRIEF DESCRIPTION OF THE DRAWINGS

FIG. 1 is a schematic diagram illustrating part of a telescopic tube in one embodiment.

FIG. 2 is a diagram illustrating an enlarged schematic view of section A of the telescopic tube shown in FIG. 1.

FIG. 3 is a schematic diagram illustrating a partial cross-sectional structural view of part of the telescopic tube shown in FIG. 1.

FIG. 4 is a diagram illustrating an enlarged schematic view of section B of the telescopic tube shown in FIG. 3.

FIG. 5 is a schematic diagram illustrating a connecting ring in the telescopic tube shown in FIG. 1.

FIG. 6 is a diagram illustrating an enlarged schematic view of section C of the connecting ring shown in FIG. 5.

FIG. 7 is a schematic diagram illustrating a partial cross-sectional structural view of part of a telescopic tube in another embodiment.

FIG. 8 is a diagram illustrating an enlarged schematic view of section D of the telescopic tube shown in FIG. 7.

FIG. 9 is a diagram illustrating an enlarged schematic view of section E of the structure shown in FIG. 8.

FIG. 10 is a schematic diagram illustrating part of a telescopic tube in another embodiment.

FIG. 11 is a diagram illustrating an enlarged schematic view of section F of the telescopic tube shown in FIG. 10.

FIG. 12 is a schematic diagram illustrating a connecting ring in the telescopic tube shown in FIG. 10.

FIG. 13 is a schematic diagram illustrating part of a telescopic tube in another embodiment.

Like reference numbers and designations in the various drawings indicate like elements.

### DETAILED DESCRIPTION

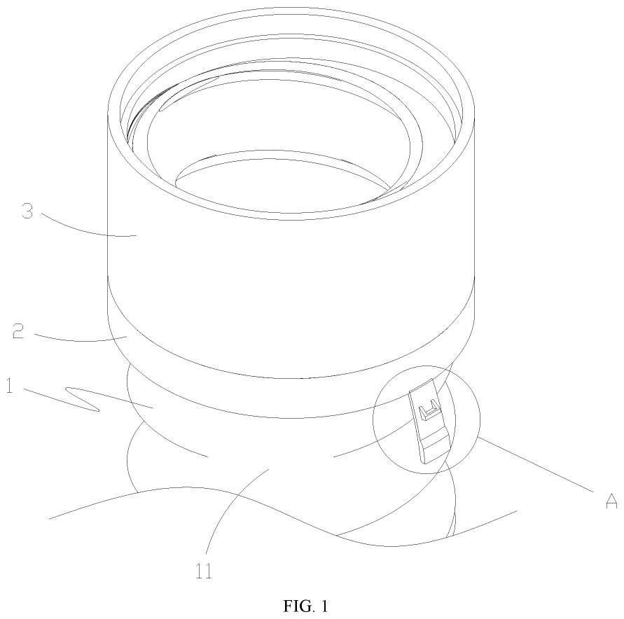

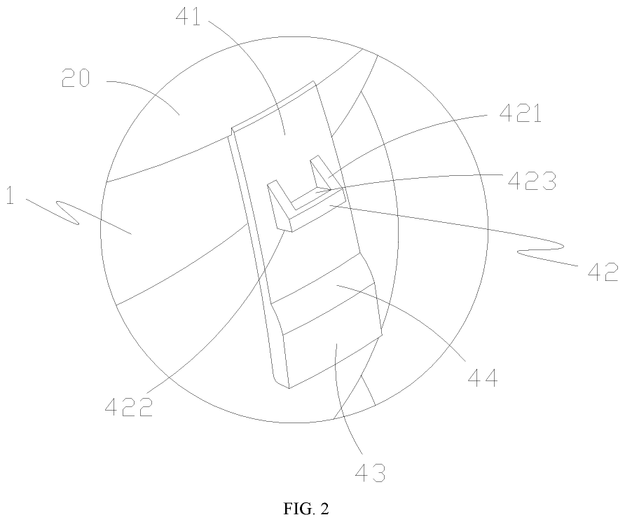

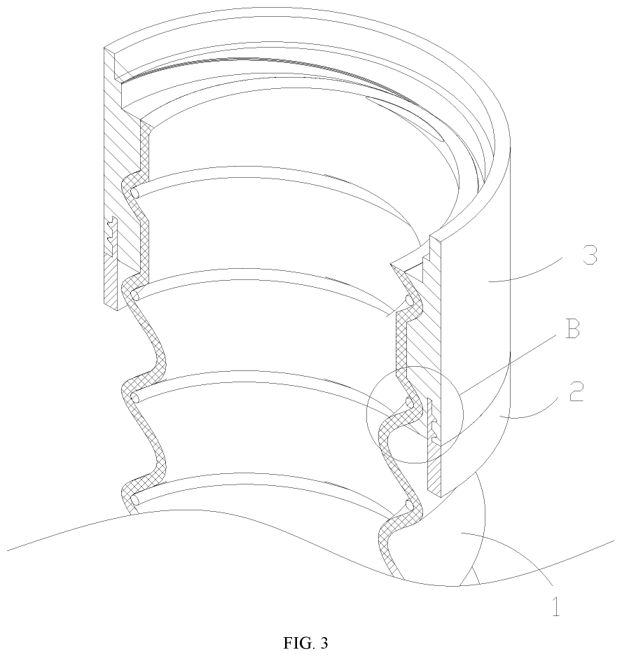

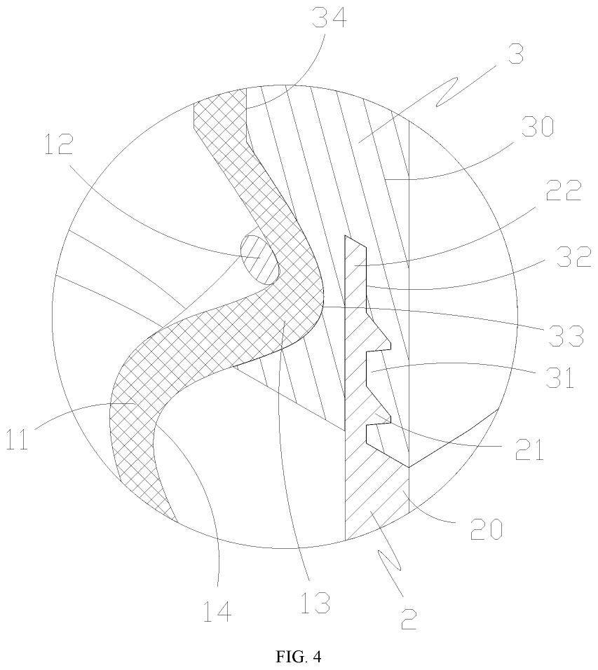

FIGS. 1-6 illustrates a method of manufacturing telescopic tubes and the resulted telescopic tube. Specifically, FIG. 1 is a schematic diagram illustrating part of a telescopic tube in one embodiment. FIG. 2 is a diagram illustrating an enlarged schematic view of section A of the telescopic tube shown in FIG. 1. FIG. 3 is a schematic diagram illustrating a partial cross-sectional structural view of part of the telescopic tube shown in FIG. 1. FIG. 4 is a diagram illustrating an enlarged schematic view of section B of the telescopic tube shown in FIG. 3.

In some embodiments, as shown in FIGS. 3-4, the method includes the following steps: First, forming a metallic wire into a coil spring 12. In some embodiments, the metallic wire can be made of, for example, spring steel or other suitable materials. Second, stretching and extending the coil spring 12. Third, spirally curing the stretched coil spring 12 (i.e., the metallic wire of the coil spring 12) to form a tube body 1. The tube body 1 has a structure similar to that of a corrugated pipe.

In some embodiments, the curing the coil spring 12 includes spirally wrapping rubber strips made of, for example, thermoplastic elastomers (TPE) material around the outside of the coil spring 12. Moreover, as shown in FIG. 4, the rubber strips adjacent in the axial direction (around which the coil spring 12 spirally circles) at least partially overlap and thus are connected together to form the wall 11 of the tube body 1. As shown in FIGS. 1 and 3, a connection ring 2 is then placed around the outer side of the tube body 1. Next, the resulted tube body 1 is stretched and extended, and the injection mold is placed to cover at least one end of the tube body 1. As shown in FIGS. 1 and 3, the connecting tube 3 is then formed at the end of the tube body 1 by applying injection molding on that end of the tube body 1. Last, as shown in FIGS. 1 and 3, after the connecting tube 3 is cooled and firmly formed, the connecting ring 2 is coupled to the connecting tube 3.

In some embodiments, two separate connecting tubes same as or similar to the connecting tube 3 are formed on the two ends of the tube body 1, respectively, by injection molding. In some embodiments, the two separate connecting tubes can be formed simultaneously on the opposite ends of the tube body 1, respectively, and the connecting ring 2 can be connected to one of the two connecting tubes at any given time. In some embodiments, the connecting tube 3 is made of relatively soft material such as, for example, soft PVC material, and the connecting ring 2 is made of relatively hard material such as, for example, hard PVC material.

Because the connecting tube 3 is formed around the outer side of the end of the tube body 1 by direct injection molding using soft PVC material, the inner surface of the connecting tube 3 and part of the outer surface of the tube body 1 are tightly adhered to each other, thus achieving an excellent sealing effect and is less prone to leaking.

Moreover, because the connecting tube 3 is formed at the end of the tube body 1 by injection molding after the tube body 1 is first stretched and extended, gaps are formed along the tube body 1 when it is stretched and extended, and as a result, the soft PVC material in the molten state flows into those gaps in the injection molding process. Thus, when the soft PVC material is cooled and hardened into a solid state, some soft PVC material solidifies in the gaps. That is, at least part of the end of the tube body 1 is tightly embedded onto the inner surface of the connecting tube 3, which makes the connection between the connecting tube 3 and the tube body 1 stronger and further improves the sealing effect therein.

Additionally, when part of the stretched and extended coil spring (which makes the tube body 1) is embedded onto the inner surface of the connecting tube 3, it also supports and fixes the connecting tube 3 which is made of soft PVC material, thus preventing the connecting tube 3 from being deformed by force. More importantly, when the connecting tube 3 is connected to other components (for example, when the telescopic tube is a hose of a vacuum cleaner that is to be connected to the main body of the vacuum cleaner via a hose inlet on one end, and to a floor nozzle via a wand on the other end), the connection is stronger, more stable and durable, and less prone to disconnection. After the coil spring is stretched and extended, only a short section of it is needed for it to be connected to the connecting tube 3, and such a connection is strong and achieves good sealing effect. Thus, it is efficient in terms of material cost too.

In some embodiments, a first connecting tube is formed on one end of a tube body by direct injection molding, and a second connecting tube is formed on the other end of the tube body by direct injection molding or any other suitable method. The two connecting tubes can each be connected to a connecting ring, respectively.

In some embodiments, as shown in FIGS. 3 and 4, a metallic wire can be formed into the coil spring 12, and at the same time, the formed coil spring 12 is spirally wrapped by rubber strips to make the tube body 1. And then the connecting ring 2 is placed around the tube body 1, after which the connecting tube 3 is formed at the end of the tube body 1 by injection molding. Last, the connecting ring 2 and the connecting tube 3 are connected. In other embodiments, other suitable manufacturing methods can be used to make such a telescopic tube.

In some embodiments, as shown in FIGS. 1-6, a telescopic tube made using the manufacturing methods described herein includes the tube body 1, the connecting tube 3, and the connecting ring 2. On one hand, the connecting tube 3 is made of relatively soft material such as, for example, soft PVC material. Thus, when the telescopic tube is connected to other components of the fluid conveying equipment (e.g., the main body of a vacuum cleaner or ironing machine), because i) it is the connecting tube 3 that is being used to connect to the tube body of the telescopic tube, and ii) the connecting tube 3 is made of relatively soft material, the connection achieves a better sealing performance and forms a removable or detachable interference fit, making use of the equipment easier and more convenient.

On the other hand, the connecting ring 2 is made of relatively hard material such as, for example, hard PVC material, which is stronger and less prone to deformation. Thus, when the connecting tube 3 is connected to the connecting ring 2, because i) it is the connecting ring 2 that is being used to connect to the connecting tube 3 on one end and to the other component of the fluid conveying equipment on the other end, and ii) the connecting ring 2 is made of relatively hard material, it prevents the connecting tube 3 (which is made of relatively soft material) from being deformed and separated from the other component, thus further strengthening the connection between the telescopic tube and the other components of the equipment.

In some embodiments, as shown in FIG. 4, the tube body 1 includes a tube wall 11 and the coil spring 12. The coil spring 12 is made by curling a metallic wire, which can be made of, for example, stainless steel or any other suitable material. The tube wall 11 is made by spirally wrapping rubber strips around the outside of the coil spring 12 after it is stretched and extended, where the rubber strips are made of, for example, TPE material or any other suitable material. Moreover, the rubber strips adjacent in the axial direction (around which the coil spring 12 spirally circles) at least partially overlap, thus forming the tube wall 11 as one piece of continuous and sealed tube wall.

Because the tube wall 11 is formed by spirally wrapping rubber strips around the outside of the stretched and extended coil spring 12, the outer surface of the tube body 1 is also in the form of a thread-like structure. As shown in FIG. 4, the tube body 1 includes convex rings like a convex ring 13 and concave rings like a concave ring 14. The convex rings and the concave rings are alternately positioned and spirally wind with each other, forming a double-helix structure. Since the connecting tube 3 is formed at the end of the tube body 1 by direct injection molding, and the tube body 1 is stretched and extended in the injection molding process, the distance between the highest point of the convex rings and the lowest point of the concave rings is relatively small for the part where the outer surface of the tube body 1 is in contact with the inner surface of the connecting ring 3.

As shown in FIG. 4, the connecting tube 3 includes a connecting tube body 30, and a first ring 33 and a second ring 34, both of which are formed on the inner wall of the connecting tube body 30. Furthermore, the first ring 33 is in contact and fits with a convex ring (e.g., the convex ring 13), and the second ring 34 is in contact and fits with a concave ring (e.g., the concave ring 14). Such a structure makes the connection between the tube body 1 and the connecting tube 3 stronger and achieves a better sealing effect therein.

In some embodiments, before the connecting tube 3 is formed by injection molding, the connecting ring 2 is placed around the outside surface of the tube body 1, and can slide back and forth along the tube body 1 so that the connecting ring 2 does not affect the injection molding of the connecting tube 3. After the connecting tube 3 is injection-molded, the connecting ring 2 can be detachably connected to the connecting tube 3 using a connection structure, as shown in FIGS. 1 and 3.

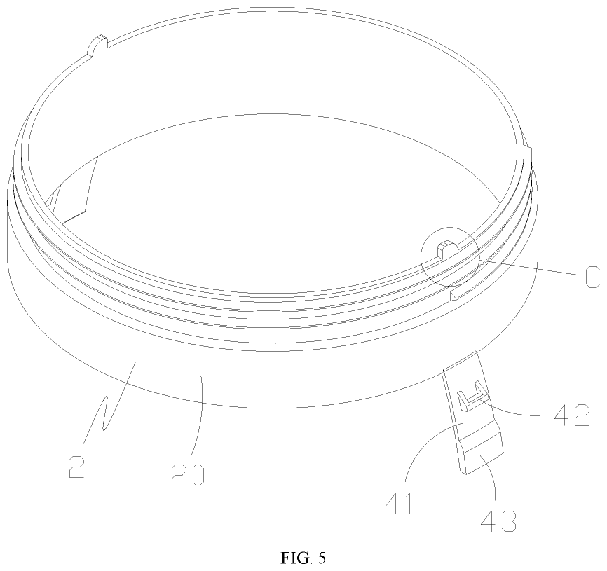

FIG. 5 is a schematic diagram illustrating the connecting ring 2 in the telescopic tube shown in FIG. 1. In some embodiments, as shown in FIG. 5, the connecting ring 2 includes a ring body 20 and a clamping structure (or snap-in structure), which enables the detachable connection between the connecting ring 2 and the other components of the fluid conveying equipment (e.g., a hose inlet or a wand of a vacuum cleaner). As shown in FIG. 5, the clamping structure includes an elastic piece 41, a buckle 42, and a clamping handle 43. In some embodiments, the elastic piece 41 is positioned on the side of the ring body 20 that is away from the connecting tube 3. That is, when the connecting tube 3 is connected with the connecting ring 2, the ring body 20 is positioned between the connecting tube 3 and the elastic piece 41. In some embodiments, the elastic piece 41 is not in contact with the connecting tube 3.

As shown in FIG. 5, the elastic piece 41 can be formed as an extension of the ring body 20. That is, the elastic piece 41 can be formed by extending at least part of the ring body 20 outward (away from the connecting tube 3 when the connecting ring 2 is connected to the connecting tube 3). The elastic piece 41 is made to be flexible so that it can undergo a certain level of elastic deformation. As shown in FIG. 5, the buckle 42 is formed on the elastic piece 41 by extending part of the surface of the elastic piece 41 outward (away from the tube body 1 when the connecting ring 2 is placed around the outside surface of the tube body 1).

The buckle 42 includes a first buckle surface, a second buckle surface, and a buckle component. The first buckle surface is connected to, and forms an inclined surface from, the surface of the elastic piece 41, thus enabling the buckle 42 to detachably connect with a slot of the other component of the fluid conveying equipment (to which the connecting ring 2 is connected). The second buckle surface is perpendicular to the surface of the elastic piece 41, thus forming an anti-detachment structure with the slot of the other component (to which the connecting ring 2 is connected). The buckle component of the buckle 42 is a slot-like structure that is opened on the first buckle surface, and the other component (to which the connecting ring 2 is connected) includes a component that fits with and can be inserted into the buckle component, making the connection between the connecting ring 2 and the other component stronger.

As shown in FIG. 5, the clamping handle 43 is formed as an extension of the elastic piece 41, or in other words, formed by extending at least part of the elastic piece 41 outward (away from the ring body 20). The surface of the clamping handle 43 is connected to the surface of the elastic piece 41 through a curved surface, which makes it easier for a user to press the elastic piece 41 since it is not easy to slip off when pressing and such a pressing by the user needs not to be very hard.

In some embodiments, the clamping structure is designed so that the elastic piece 41 and the outer surface of the ring body 20 form an angle of, for example, 1°-30°. With such an angle, when the connecting tube 3 is injection-molded on one end of the tube body 1, the connecting ring 2 can slide away from that end of the tube body 1 as far as possible, so to ensure smooth injection molding at that end of the tube body 1. In other words, the non-zero angle prevents the clamping structure from being in contact and thus obstructed by the other end of the tube body 1, so that the connecting ring 2 can be away, as far as possible, from the end of the tube body 1 where the connecting tube 3 is injection-molded.

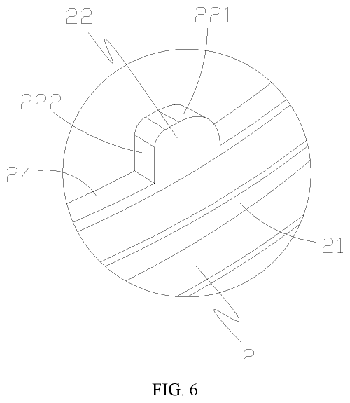

FIG. 6 is a diagram illustrating an enlarged schematic view of section C of the connecting ring 2 shown in FIG. 5. In some embodiments, as shown in FIGS. 4 and 6, the connection structure includes an external thread 21, an internal thread 31, a clamping block 22, and a clamping groove 32. As shown in FIG. 6, the ring body 20 has, at the side close to the connecting tube body 30, a ring protrusion 24, which is formed by extending part of one surface of the ring body 20 outward and is positioned on the inner side of the ring body 20. The external thread 21 is positioned on the outer side of the ring protrusion 24. The clamping block 22 is formed by extending part of one surface of the ring protrusion 24 outward.

As shown in FIG. 4, the connecting tube body 30 has, at the side close to the ring body 20, a ring groove, which is formed by indenting part of one surface of the connecting tube body 30 inward. The internal thread 31 is positioned at the inner wall of the ring groove, and a clamping groove 32 is positioned at the bottom of the ring groove. The ring protrusion 24 can be inserted into and fit with the ring groove, making the external thread 21 and the internal thread 31 to form a screw connection. When the ring protrusion 24 is screwed into the bottom of the ring groove, the clamping block 22 is inserted into and fits with the clamping groove 32.

As shown in FIG. 6, the clamping block 22 has a first surface 221 and a second surface 222. The first surface 221 is a surface with an arc shape. When the connecting tube 3 is connected to the connecting ring 2, the clamping block 22 on the ring protrusion 24 will first be in contact with the bottom of the ring groove. At this time, the first surface 221 can reduce the friction between the ring protrusion 24 and the ring groove, and also press the connecting tube 3 (which is made of relatively soft material such as soft PVC) to make it elastically deformed. This causes the connecting ring 2 to be continuously screwed into the ring groove of the connecting tube 3 until the clamping block 22 is fully inserted into and fits with the clamping groove 32, at which time the surface of the ring body 20 is in contact and fits with the surface of the connecting tube body 30. As shown in FIGS. 4 and 6, the second surface 222 of the clamping block 22 is a vertical and flat surface, which is in contact and fits with an inner wall of the clamping groove 32. Thus, the clamping block 22 and the clamping groove 32 together form an anti-detachment structure to prevent accidental separation of the connecting ring 2 from the connecting tube 3, making their connection stronger.

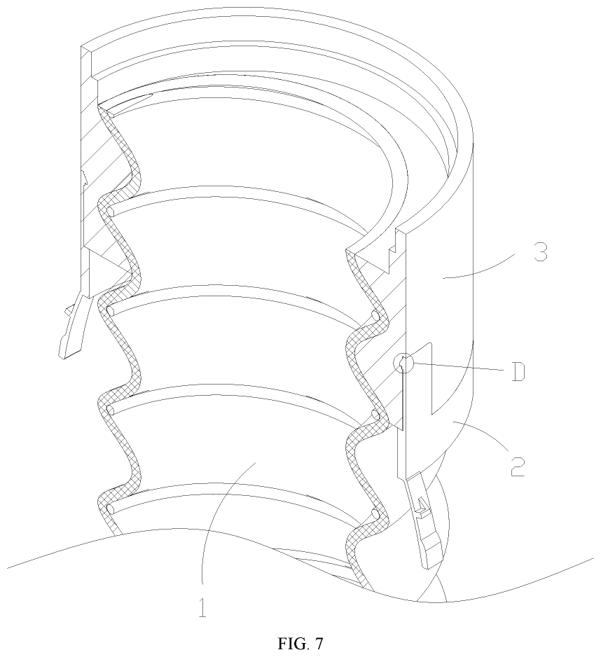

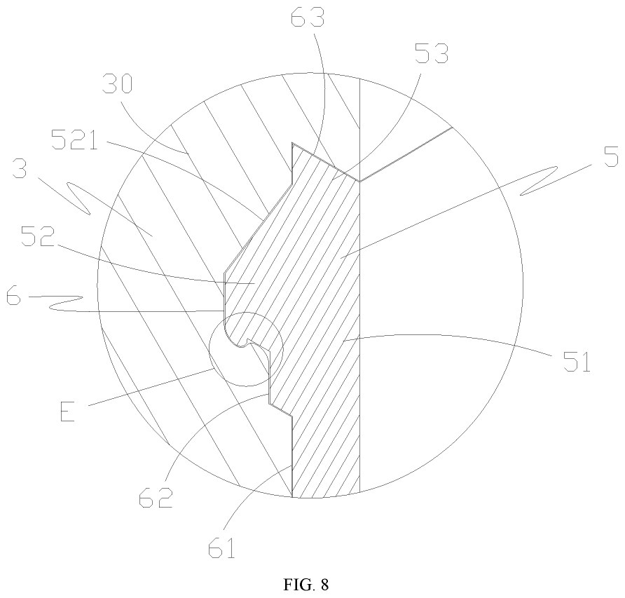

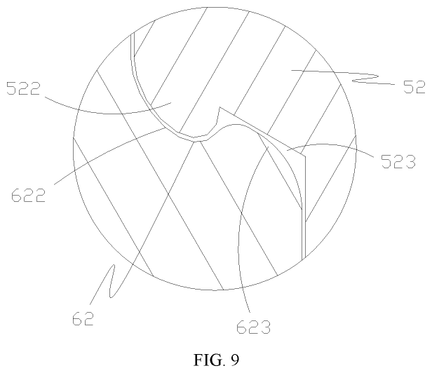

FIGS. 7-9 illustrate another method of manufacturing telescopic tubes that is different from the method illustrated in FIGS. 1-6 and described above. The difference is mainly at the connection structure that enables detachable connection of the connecting ring 2 and the connecting tube 3. Specifically, FIG. 7 is a schematic diagram illustrating a partial cross-sectional structural view of part of a telescopic tube in another embodiment. FIG. 8 is a diagram illustrating an enlarged schematic view of section D of the telescopic tube shown in FIG. 7. FIG. 9 is a diagram illustrating an enlarged schematic view of section E of the structure shown in FIG. 8.

As shown in FIGS. 7 and 8, the connection structure includes a plug 5 formed on the connecting ring 2 and a slot 6 formed on the connecting tube 3. The plug 5 can be inserted into and fit with the slot 6, thus tightly connecting the connecting ring 2 with the connecting tube 3. In some embodiments, a similar plug can be formed on a connecting tube and correspondingly a similar slot can be formed on a connecting ring.

As shown in FIG. 8, the plug 5 includes a plug body 51 and an anti-detachment block 52. The plug body 51 is connected to the ring body 20. The anti-detachment block 52 is formed on the side of the plug body 51 that is away from the ring body 20, and separated from the ring body 20 by a distance formed by an end block 53. The slot 6 has a long groove 61, an anti-detachment groove 62, and an end groove 63. The plug body 51 is in contact and fits with the long groove 61, the anti-detachment block 52 is in contact and fits with the anti-detachment groove 62, and the end block 53 is in contact and fits with the end groove 63. Thus, when the connecting tube 3 is connected with the connecting ring 2, the connection has a smooth and beautiful surface, and is less prone to separation.

Furthermore, as shown in FIGS. 8-9, the anti-detachment block 52 has an inclined surface 521, an anti-detachment protrusion 522, and an anti-detachment groove 523, all of which enable a smooth and easy insertion of the plug 5 into the slot 6. The contact and fit between the end block 53 and the end groove 63 prevents the plug 5 from sliding away from the slot 6 along the inclined surface 521, which makes the connection stronger.

Similarly, the anti-detachment groove 62 has a groove indentation 622 and a groove protrusion 623. The anti-detachment protrusion 522 can be inserted into and fit with the groove indentation 622, and the groove protrusion 623 can be inserted into and fit with the anti-detachment groove 523, Such a structure is a further anti-detachment structure between the anti-detachment block 52 and the anti-detachment groove 62, which makes the connection stronger.

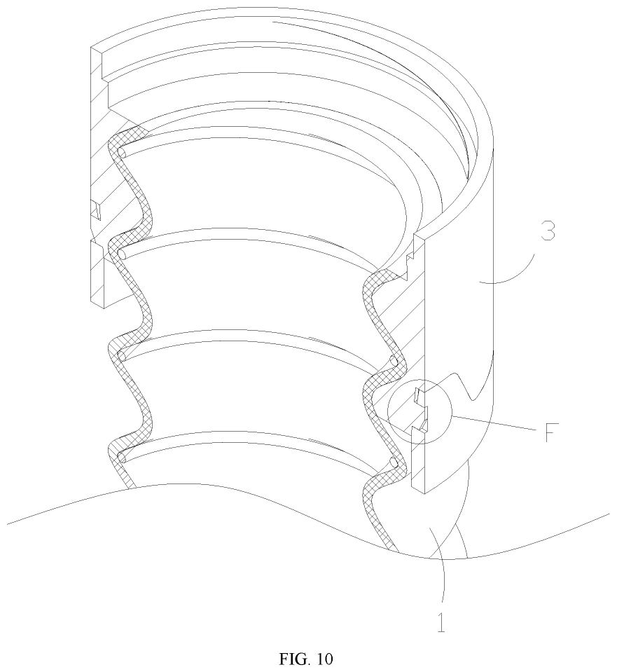

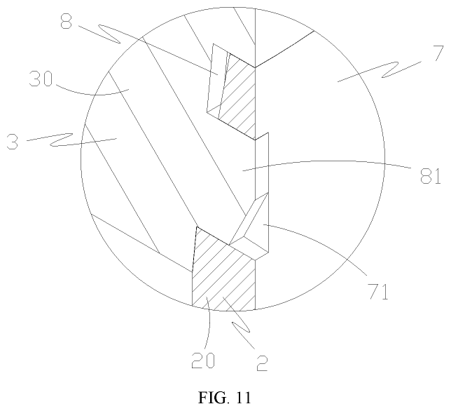

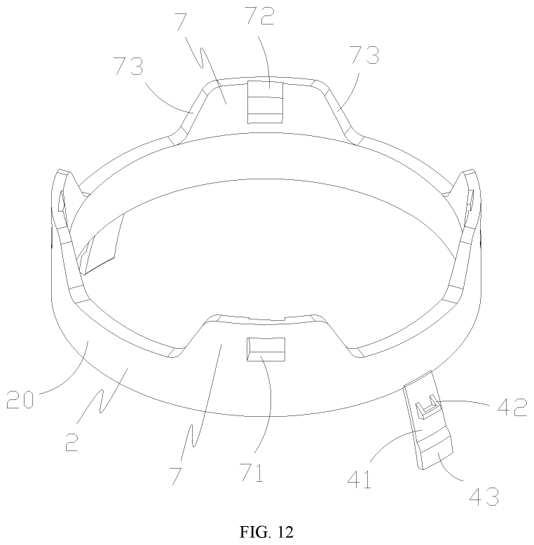

FIGS. 10-12 illustrate another method of manufacturing telescopic tubes that is different from the method illustrated in FIGS. 1-6 and described above. The difference between this method and the method shown and described with respect to FIGS. 1-6 is mainly at the connection structure that enables detachable connection of the connecting ring 2 and the connecting tube 3. Specifically, FIG. 10 is a schematic diagram illustrating part of a telescopic tube in another embodiment. FIG. 11 is a diagram illustrating an enlarged schematic view of section F of the telescopic tube shown in FIG. 10. FIG. 12 is a schematic diagram illustrating a connecting ring in the telescopic tube shown in FIG. 10.

As shown in FIGS. 10 and 11, the connection structure includes a connecting portion 7 formed on the connecting ring 2 and a connecting groove 8 formed on the connecting tube 3. The connecting portion 7 can be inserted into and fit with the connecting groove 8, thus tightly connecting the connecting ring 2 and the connecting tube 3. In some embodiments, a similar connecting portion can be formed on a connecting tube and correspondingly a similar connecting groove can be formed on a connecting ring.

As shown in FIG. 11, the connecting portion 7 is formed by extending the ring body 20 outward. The connecting portion 7 has an inclined surface at the side close to the tube body 1, which is inclined from its part close to the ring body 20 toward its part away from the ring body 20, and also is inclined from its part close to tube body 1 toward its part away from the tube body 1. Thus, when the connecting ring 2 is connected to the connecting tube 3, the connecting portion 7 can be easily inserted into and fit with the connecting groove 8.

As shown in FIGS. 11 and 12, the connecting portion 7 has a through groove 71, and correspondingly the connecting groove 8 has a groove block 81, which is formed by extending part of the connecting groove 8 outward. When the connecting portion 71 is in contact and fits with the connecting groove 8, the groove block 81 is inserted into and fits with the through groove 71.

As shown in FIGS. 11 and 12, the connecting portion 7 has an inclined groove 72, which is connected to the through groove 71 and is positioned at the side of the through groove 71 that is away from the ring body 20. That is, the through groove 71 is positioned between the ring body 20 and the inclined groove 72. The bottom surface of the inclined groove 72 is inclined from its part close to the ring body 20 toward its part away from the ring body 20, and also is inclined from its part close to the tube body 1 toward its part away from the tube body 1. Such a structure makes it easier for the groove block 81 to pass through the inclined groove 72 to be inserted into the through groove 71 because it creates less resistance in the process. As shown in FIG. 12, the connecting portion 7 has a connecting slope 73 on its both sides, which further makes it easier to align and connect the connecting portion 7 with the connecting groove 8.

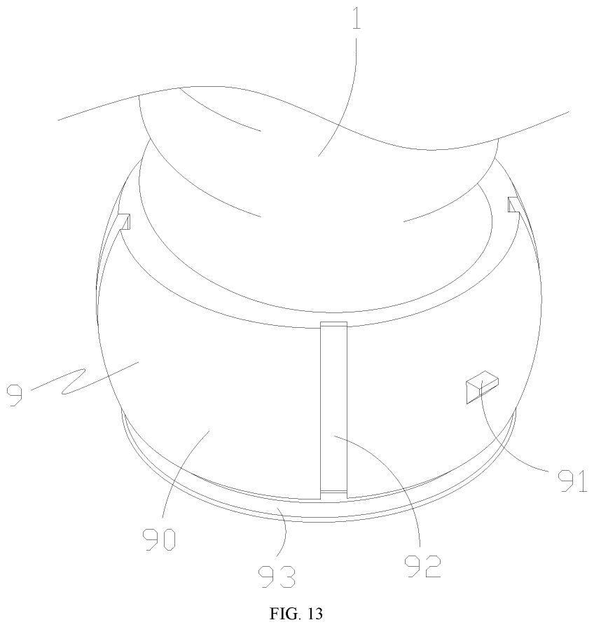

FIG. 13 is a schematic diagram illustrating part of a telescopic tube in another embodiment, which is different from that shown and described with respect to FIGS. 1-6 above. The difference is mainly at the joints positioned at the two ends of a tube body. Specifically, FIG. 13 shows a joint 9 that is different from the connecting tube 3, which functions as a joint as shown and described above with respect to FIGS. 1-6. In some embodiments, a telescopic tube can have two connecting tubes same as or similar to the connecting tube 3 at both ends of its tube body, two joints same as or similar to the joint 9 at both ends of its tube body, or one connecting tube and one joint at the two ends of its tube body, respectively.

In some embodiments, same as the connecting tube 3, the joint 9 is also formed by direct injection molding on the end of a tube body (e.g., the tube body 1). Specifically, as shown in FIG. 13, the joint 9 includes a joint body 90, a connecting block 91, a connecting groove 92, and a connecting edge 93. The outer surface of the connecting body 90 has an arc-shaped structure. Specifically, the diameter measured at the two ends of the connecting body 90 is shorter than the diameter measured in the middle of the connecting body 90. Correspondingly, the elastic piece 41 (as shown and described above with respect to FIGS. 5 and 12) has an arc structure too, which further prevents the clamping structure (including the elastic piece 41) from being in contact and thus obstructed by the joint 9 (including the connecting body 90).

As shown in FIG. 13, the connecting block 91 is formed by extending part of the connecting body 90 outward. The cross section of the connecting block 91 has a right-angled trapezoidal shape. The connecting groove 92 is formed on the outer surface of the connecting body 90, which is used to enable fixation and anti-rotation when the joint 9 is connected to the other component of the fluid conveying equipment (e.g., the main body of a vacuum cleaner or ironing machine). The connecting edge 93 is formed on the end of the joint 9 that is away from the tube body 1. It has a flared structure to facilitate the connection between the joint 9 and the other component of the fluid conveying equipment, and also to achieve better sealing effect for that connection.

It is worthwhile to further note that, the terms “include”, “comprise”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

A person skilled in the art can easily figure out other implementations of the present specification after considering the specification and practicing the present specification here. The present specification is intended to cover any variations, uses, or adaptations of the present specification, and these variations, uses, or adaptations follow the general principles of the present specification and include common knowledge or conventional techniques that are not disclosed in the technical field of the present specification. The specification and the implementations are merely considered as examples, and the actual scope and the spirit of the present specification are specified by the appended claims.

It should be understood that the present specification is not limited to the previously described precise structures shown in the drawings, and various modifications and changes can be made without departing from the scope of the present specification. The scope of the present specification is limited by the appended claims only.

The previous descriptions are some implementations of the present specification, and are not intended to limit the present specification. A person skilled in the art can make various modifications and changes to the present specification. Any modification, equivalent replacement, or improvement made without departing from the spirit and principle of the present specification shall fall within the protection scope of the present specification.

What is claimed is:

1. A method of manufacturing telescopic tubes comprising the steps of:
placing a connecting ring around a tube body of a telescopic tube;
forming a connecting tube at one end of the tube body by injection molding so that the connecting ring is positioned between the connecting tube and the other end of the tube body; and
coupling the connecting ring with the connecting tube.

2. The method of claim 1, wherein forming the connecting tube at one end of the tube body by injection molding comprises stretching and extending the tube body before the injection molding operation.

3. The method of claim 1, further comprising, before the placing the connecting ring on the outer side of the tube body:
forming a metallic wire into a coil spring;
stretching and extending the coil spring; and
curing the stretched coil spring to form the tube body.

4. The method of claim 3, wherein the stretching and extending the coil spring and the curing the stretched coil spring to form the tube body are performed simultaneously.

5. A telescopic tube comprising:
a tube body;
a connecting tube formed at one end of the tube body by injection molding; and
a connecting ring placed around the tube body and positioned between the connecting tube and the other end of the tube body.

6. A telescopic tube according to claim 5, wherein the connecting ring and the connecting tube are detachably coupled with each other using a connection structure.

7. A telescopic tube according to claim 6, wherein the connection structure includes a thread.

8. A telescopic tube according to claim 6, wherein the connection structure includes a buckle and a slot.
